(19) United States
(12) Patent Application Publication
(10) Pub. No.: US 2026/0126169 A1
(43) Pub. Date: May 7, 2026

(54) LIGHTING SYSTEM

(71) Applicant: ARKTURA LLC, Carson, CA (US)

(72) Inventor: Jesus VARGAS, Vista, CA (US)

(73) Assignee: ARKTURA LLC, Carson, CA (US)

(21) Appl. No.: 19/371,368

(22) Filed: Oct. 28, 2025

Related U.S. Application Data
(60) Provisional application No. 63/716,085, filed on Nov. 4, 2024.

(51) Int. Cl. F21V 23/00; F21S 8/02; F21Y 115/10

(52) U.S. Cl. CPC F21V 23/005; F21S 8/026; F21Y 2115/10

(57) ABSTRACT

A ceiling system comprising a grid frame, one or more ceiling panels attached to the grid frame, and one or more ladder lighting assemblies is disclosed. Each ladder lighting assembly comprises a plurality of printed circuit board rungs connected by a data line configured to provide a control signal to the printed circuit boards. Each printed circuit boards comprises lights thereon that are controlled by the control signal. Each printed circuit board can also comprise detachable segments, or nodes, to accommodate various building structures and/or room dimensions.

### CROSS-REFERENCED TO RELATED APPLICATIONS

The present application claims the benefit of priority to U.S. Provisional Patent Application Ser. No. 63/716,085, filed Nov. 4, 2024, the entirety of which is incorporated herein by reference.

### FIELD OF THE INVENTION

The present invention relates to lighting systems for use with wall panel systems and/or suspended ceiling systems, for example.

### BACKGROUND

In various instances, backlighting has been used to provide lighting solutions, especially when used in connection with wall panel systems and/or suspended ceiling systems. Such backlighting, however, has to accommodate various building structures, such as windows, fire alarms, and/or water sprinklers, for example. Modifying the backlighting to accommodate such building structures can be challenging. Moreover, controlling the backlighting, especially after it has been modified, can create additional challenges. Disclosed herein are solutions to these challenges, among others.

### SUMMARY

The present invention provides, in one form, a ceiling system including a grid support having grid support members, ceiling panels having torsion springs mounted thereto, spring clips configured to snap-lock onto the grid support members for coupling the torsion springs of the ceiling panels to the grid support, and lighting assemblies positioned behind the ceiling panels. Each lighting assembly comprises printed circuit boards arranged in a ladder-like arrangement and a data line extending between the printed circuit boards. In various embodiments, the printed circuit boards comprise segments that can be detached therefrom to accommodate various building structures and/or room dimensions.

The present invention provides, in one form, a ladder lighting assembly comprising a first printed circuit board and a second printed circuit board. The first printed circuit board comprises a first group of light emitting diodes, a first control circuit configured to control the first group of light emitting diodes, a first power terminal in electrical communication with the first control circuit, a first data input terminal in electrical communication with the first control circuit, and a first data output terminal. The second printed circuit board comprises a second group of light emitting diodes, a second control circuit configured to control the second group of light emitting diodes, a second power terminal in electrical communication with the second control circuit, a second data input terminal in electrical communication with the second control circuit, and a second data output terminal. The ladder lighting assembly further comprises a power line connected to the first power terminal and the second power terminal and a data line comprising a first data line segment connected to the first data input terminal, a second data line segment connected to the first data output terminal and the second data input terminal, and a third data line segment connected to the second data output terminal.

The present invention provides, in one form, a ladder lighting assembly comprising a plurality of printed circuit board rungs, each printed circuit board rung comprising a first node and a second node. The first node comprises a first board segment, a first group of light emitting diodes, a first control circuit configured to conduct a control signal, a first driver circuit in electrical communication with the first control circuit, wherein the first driver circuit is configured to control the first group of light emitting diodes in response to the control signal, a first power terminal in electrical communication with the first driver circuit; and a first signal terminal in electrical communication with the first control circuit. The second node comprises a second board segment removably attached to the first board segment, a second group of light emitting diodes, a second control circuit in electrical communication with the first control circuit configured to conduct the control signal, a second driver circuit in electrical communication with the second control circuit, wherein the second driver circuit is configured to control the second group of light emitting diodes in response to the control signal, and a second signal terminal in electrical communication with the second control circuit. The ladder lighting assembly further comprises a data line connecting the second signal terminal of one of the printed circuit board rungs to the first signal terminal of another one of the printed circuit board rungs.

The present invention provides, in one form, a lighting assembly comprising a plurality of circuit boards arranged in a ladder-like manner, wherein each circuit board comprises a first node comprising a first group of light emitting diodes and a first control circuit including a first data terminal, a second node comprising a second group of light emitting diodes and a second control circuit including a second data terminal, wherein the first node is detachably attached to the second node on a first side of the second node, wherein the second control circuit is electrically connected to the first control circuit when the first node and the second node are attached, and wherein the second control circuit is electrically disconnected from the first control circuit when the first node is detached from the second node, and a third node comprising a third group of light emitting diodes and a third control circuit including a third data terminal, wherein the third node is detachably attached to the second node on an opposite side of the second node, wherein the third control circuit is electrically connected to the second control circuit when the second node and the third node are attached, and wherein the second control circuit is electrically disconnected from the third control circuit when the third node is detached from the second node. The lighting assembly further comprises a data line selectively couplable to at least one of the first data terminal, when the first node is attached to the second node, the second data terminal, and the third data terminal, when the third node is attached to the second node, of each circuit board.

The present invention provides, in one form, a lighting assembly for use with a ceiling panel system, the lighting assembly comprising a plurality of circuit boards, wherein each circuit board comprises a plurality of severable nodes, and a data circuit extending through the plurality of circuit boards.

### BRIEF DESCRIPTION OF THE DRAWINGS

The features of the exemplary embodiments of the present invention will be described with reference to the following drawings, where like elements are labeled similarly, and in which:

FIG. 1 is an exploded view of a ceiling system including an overhead suspended support grid, ceiling panels attachable to the support grid, a ladder light system positionable behind the ceiling panels, and a translucent backer;

FIG. 2 is a perspective view of the ceiling system of FIG. 1;

FIG. 3 is a plan view of the ceiling system of FIG. 1;

FIG. 4 is an exploded view of the ceiling system of FIG. 1 adapted to accommodate a building structure;

FIG. 5 is a perspective view of the ceiling system of FIG. 4;

FIG. 6 is a plan view of the ceiling system of FIG. 4;

FIG. 7 is a plan view of a printed circuit board of the ladder light system of FIG. 1;

FIG. 7A is a detail view of a power terminal of the printed circuit board of FIG. 7;

FIG. 7B is a detail view of a breakable interface between a first board segment and a second board segment of the printed circuit board of FIG. 7;

FIG. 8 is an elevational view of the printed circuit board of FIG. 7;

FIG. 9 is a perspective view of an electrical connector of a power line connected to a power terminal of the printed circuit board of FIG. 7;

FIG. 10 is a plan view of the ladder light system of FIG. 1;

FIG. 11 illustrates two printed circuit boards of the ladder light system of FIG. 1;

FIG. 12 illustrates a segment broken off one of the printed circuit boards of FIG. 11 in a manner similar to that seen in FIGS. 4-6; and

FIG. 13 illustrates several segments broken off the printed circuit boards of FIG. 11.

Parts given a reference numerical designation in one figure may be considered to be the same parts where they appear in other figures without a numerical designation for brevity unless specifically labeled with a different part number and described herein.

### DETAILED DESCRIPTION

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

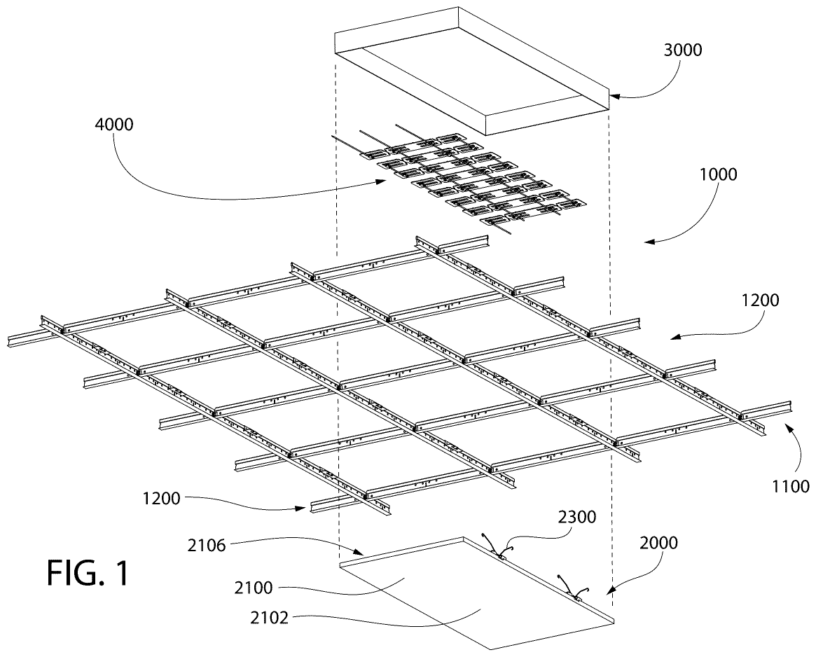

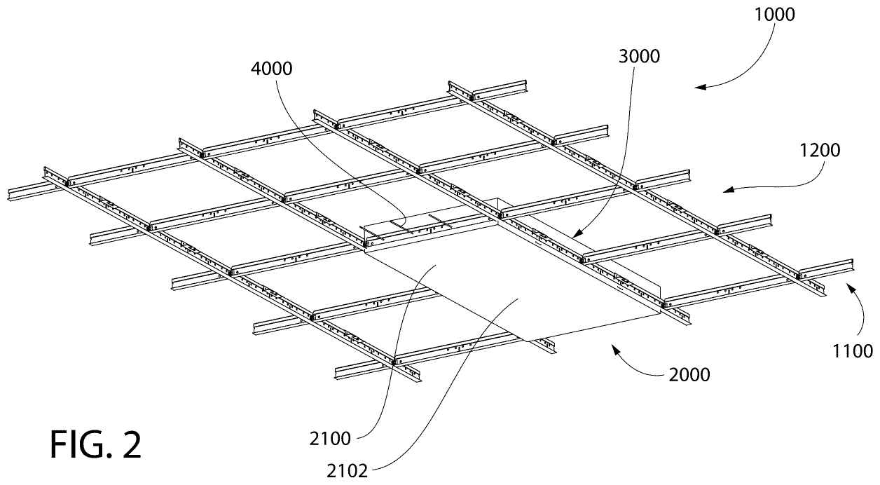

FIGS. 1-3 depict a ceiling system including an overhead support grid 1000 mountable in a suspended manner from an overhead building support structure. The support grid 1000 includes a plurality intersecting longitudinal grid support members 1100 and lateral grid support members 1200. The grid support members 1100, 1200 are elongate in shape having a length greater than their respective width. The longitudinal grid support members 1100 may have a substantially greater length than the lateral grid support member 1100 and form “runners” or “rails” which are maintained in a substantially-parallel spaced-apart relationship by the lateral grid support members 1200. The lateral grid support members 1200 may be attached between adjacent (but spaced apart) longitudinal grid support members 1100 at appropriate intervals using any suitable permanent or detachable manner. The combination of interconnected longitudinal and lateral grid support members 1100 and 1200 provides lateral stability to the support grid 1000. The grid support members 1100, 1200 can be comprised of any suitable material such as stainless steel and/or aluminum, for example.

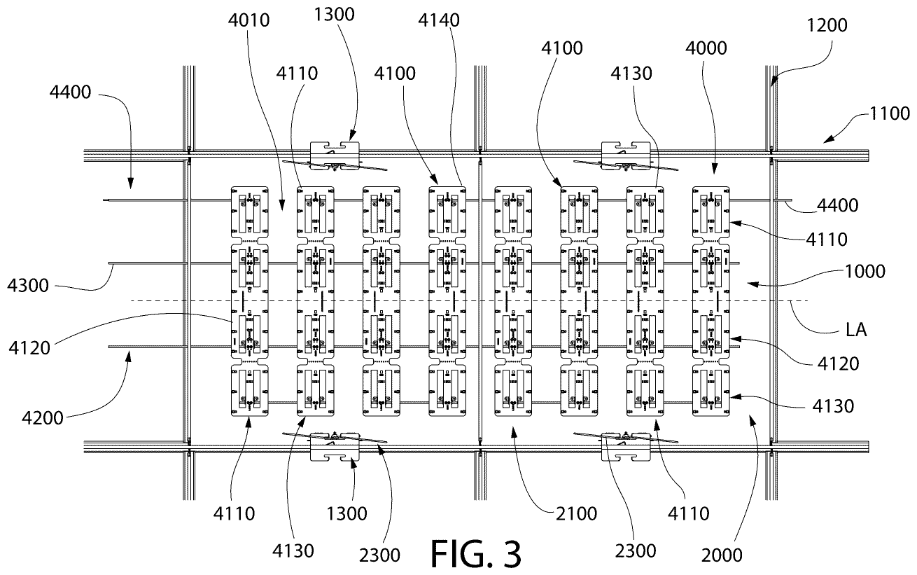

Further to the above, referring again to FIGS. 1-3, the ceiling system 1000 further comprises ceiling panels 2000 that are attachable to the support grid 1000. Each ceiling panel 2000 has a generally flat body 2100 that includes a top surface, a bottom surface 2102 positioned opposite the top surface, and lateral sides 2103 extending therebetween along four sides of the ceiling panel 2000. The ceiling panel 2000 has a generally rectangular shape but can have any suitable shape. In various instances, the ceiling panel 2000 can have irregular surfaces including various undulating patterns, designs, textures, perforations, ridges/valleys, wavy raised features, and/or other configurations for aesthetic and/or acoustic (e.g. sound reflection or dampening) purposes. The ceiling panels 2000 are constructed of any suitable material including, without limitation, mineral fiber board, fiberglass, jute fiber, metals, polymers, wood, and/or other materials, for example. The ceiling panels 2000 are mounted to the support grid 1000 using torsion springs 2300 and snap-on slideable slotted spring clips 1300 (FIG. 3) which are movably mounted on the support grid 1000. Each torsion spring 2300 includes a coil and two upwardly-projecting arms which are disposed at angle in relation to each other forming a characteristic V-shape. The arms of the torsion springs 2300 have recurved or hooked ends configured to engage the spring clips 1300. The torsion springs 2300 may be formed of a suitable spring material such as, without limitation, steel wire having an elastic memory, for example. Various other embodiments are contemplated that do not use torsion springs 2300 or spring clips 1300. In such embodiments, any other suitable connectors to suspend and/or support the ceiling panels 2000 can be used.

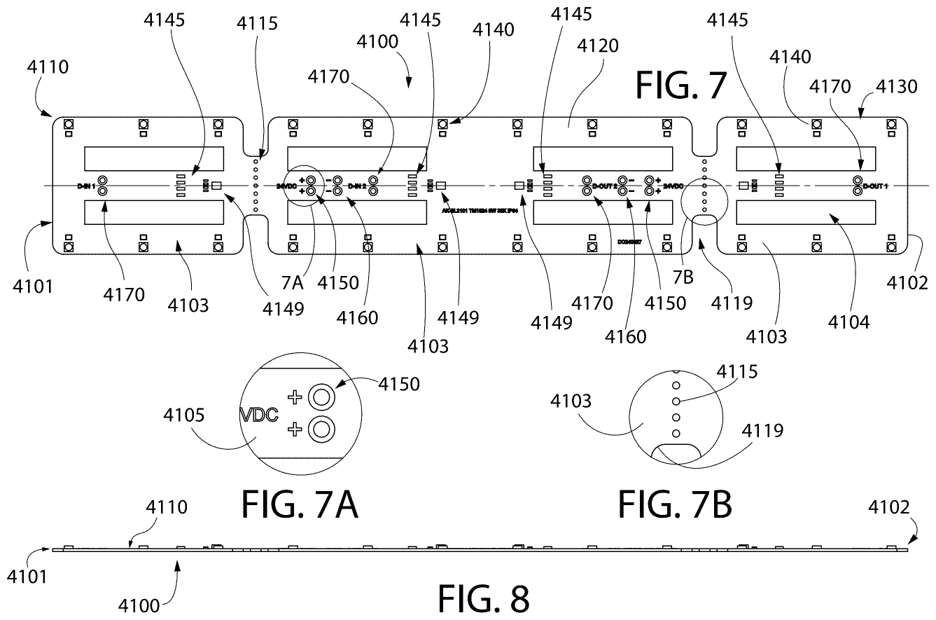

Further to the above, referring again to FIGS. 1-3, the ceiling system 1000 further comprises a lighting system positioned behind the ceiling panels 2000. The lighting system comprises ladder lighting assemblies 4000 positioned behind the ceiling panels 2000 that create a pleasant, or aesthetic, background lighting effect. Each ladder lighting assembly 4000 comprises a plurality of printed circuit boards 4100 arranged in a parallel, or an at least substantially parallel, arrangement along a longitudinal ladder axis LA. The printed circuit boards 4100 are arranged in a planar, or an at least generally planar, relationship; however, in various other instances, the printed circuit boards 4100 of a ladder lighting assembly 4000 can be positioned in offset planes and/or oriented in a non-planar manner relative to one another. The printed circuit boards 4100 are separated from one another along the longitudinal ladder axis LA by gaps 4010 but are connected by a power line 4200, a ground line 4300, and a signal, or data, line 4400. As discussed in greater detail below, each printed circuit board 4100 comprises one or more lights, such as light emitting diodes (LEDs) 4140 (FIG. 7), for example, thereon. As also discussed in greater detail below, each printed circuit board 4100 comprises power terminals 4150 configured to be electrically connected to the power line 4200, ground terminals 4160 configured to be electrically connected to the ground line 4300, and data terminals 4170 configured to be electrically connected to the data line 4400. The power line and the ground line 4300 are part of an electrical circuit that supplies power to the LEDs 4140. As also discussed in greater detail below, the data line 4400 is configured to provide a control signal to the printed circuit boards 4100 to control the LEDs 4140.

Further to the above, referring to FIGS. 3 and 10, the printed circuit boards 4100 in each ladder lighting assembly 4000 are laterally aligned with one another such that the power terminals 4150 on a first printed circuit board 4100 are longitudinally aligned with the power terminals 4150 on a second printed circuit board 4100, as well as the power terminals 4150 on all of the printed circuit boards 4100 of the ladder lighting assembly 4000. Similarly, the printed circuit boards 4100 in each ladder lighting assembly 4000 are laterally aligned with one another such that the ground terminals 4160 of the first printed circuit board 4100 are longitudinally aligned with the ground terminals 4160 on the second printed circuit board 4100, as well as the ground terminals 4160 on all of the printed circuit boards 4100 of the ladder lighting assembly 4000. Also, similarly, the printed circuit boards 4100 in each ladder lighting assembly 4000 are laterally aligned with one another such that the data terminals 4170 of the first printed circuit board 4100 are longitudinally aligned with the data terminals 4170 on the second printed circuit board 4100, as well as the data terminals 4170 on all of the printed circuit boards 4100 of the ladder lighting assembly 4000. As a result of the above, the power line 4200 and the ground line 4300 can each extend along a longitudinal axis between the printed circuit boards 4100 of the ladder lighting assembly 4000. Moreover, as a result of this arrangement, the printed circuit boards 4100, power line 4200, and the ground line 4300 approximate a ladder-like arrangement with the printed circuit boards 4100 approximating the rungs of a ladder and the power and ground lines 4200 and 4300 approximating the rails of the ladder.

Further to the above, referring to FIG. 1, a ladder lighting assembly 4000 is configured to fit behind a ceiling panel 2000. The perimeter of the ceiling panel 2000 encompasses the ladder lighting assembly 4000 such that the ladder lighting assembly 4000 does not extend beyond the lateral perimeter of the ceiling panel 2000. In various instances, as a result, the footprint of the ceiling panel 2000 is larger than the footprint of the ladder lighting assembly 4000. That said, the ladder lighting assembly 4000 and the ceiling panels 2000 can comprise any suitable configuration. Referring to FIGS. 3, 7, 8, 10, and 11, each of the printed circuit boards 4100 of the ladder lighting assembly 4000 has the same mechanical footprint. For instance, the lateral and longitudinal dimensions of the printed circuit boards 4100 are the same. That said, the lateral and longitudinal dimensions of the printed circuit boards 4100 can be different in other embodiments. Moreover, each of the printed circuit boards 4100 of the have the same electrical footprint. For instance, further to the above, the power terminals 4150, the ground terminals 4160, and the data terminals 4170 are longitudinally aligned with one another. As a result of the above, the printed circuit boards 4100 can be interchangeable with one another. Moreover, the printed circuit boards 4100 of a ladder lighting assembly 4000 can be identical to one another.

Further to the above, referring to FIGS. 3, 10, and 11, the printed circuit boards 4100 of the ladder lighting assembly 4000 are arranged in an alternating manner. Each printed circuit board 4100 has a body 4103 including a first end 4101 and a second end 4102 opposite the first end 4101 and, for a first printed circuit board 4100 and an adjacent second printed circuit board 4100 of the ladder lighting assembly 4000, the second end 4102 of the second printed circuit board 4100 is longitudinally aligned with the first end 4101 of the first printed circuit board 4100 and, likewise, the first end 4101 of the second printed circuit board 4100 is longitudinally aligned with the second end 4102 of the first printed circuit board 4100. Even with this alternating arrangement of the printed circuit boards 4100, the power terminals 4150 remain longitudinally aligned with one another, the ground terminals 4160 remain longitudinally aligned with one another, and the data terminals 4170 remain longitudinally aligned with one another. This arrangement is possible owing to a symmetrical arrangement of the printed circuit boards 4100 about a centerline 4105.

Although the printed circuit boards 4100 can have any suitable arrangement, each printed circuit board 4100 comprises a first end board segment, or node, 4110, a middle board segment, or node, 4120, and a second end board segment, or node, 4130. The middle node 4120 is symmetrical with respect to the centerline 4105 and the first and second end nodes 4110 and 4130 collectively create a symmetrical arrangement with respect to the centerline 4105. As part of the middle node 4120 being symmetrical with respect to the centerline 4105, the middle node 4120 comprises a first set of power terminals 4150, ground terminals 4160, and data terminals 4170 on a first side of the centerline 4105 and a mirror-image second set of power terminals 4150, ground terminals 4160, and data terminals on a second, or opposite, side of the centerline 4105. The above being said, various embodiments are envisioned in which the printed circuit boards of a lighting assembly are not symmetrical. In some such embodiments, the terminals 4150, 4160, and 4170 on adjacent printed circuit boards may not be longitudinally aligned with one another.

Further to the above, each printed circuit board 4100 comprises an electrical circuit, or bus, configured to receive a control signal from a controller via data terminals 4170 on the first end node 4110. Further to the above, each printed circuit board 4100 comprises LEDs 1040 that are controlled by the control signal. The first end node 4110 of the printed circuit board 4100 has six LEDs 1040, the middle node 4120 has 12 LEDs 1040, and the second end node 4130 has six LEDs 1040. That said, the first end node 4110, the middle node 4120, and the second end node 4130 can have any suitable number of LEDs 1040. The six LEDs 1040 of the first end node 4110 are arranged along the perimeter thereof with three LEDs 1040 positioned on one side of the first end node 4110 and the other three LEDs 1040 positioned on the opposite side. The six LEDs 1040 of the first end node 4110 are controlled by a driver circuit including a microchip 4149 and four channel resistors 4145. The microchip 4149 can comprise any suitable chip. The microchip 4149 comprises 8 pins, but can comprise any suitable number of pins. One of the pins of the microchip 4149 comprises an input that is in communication with the electrical circuit running through the printed circuit board 4100 such that the microchip 4149 can receive the control signal being transmitted therein. Four of the pins of the microchip 4149 comprise outputs in communication with the LEDs 4140 of the first node 4110 via the channel resistors 4145. Each of the four outputs supplies a modulated voltage potential to the LEDs 4140 that controls the color, or colors, emitted by the LEDs 4140. For instance, the four output pins of the microchip 4149 can present four different control voltages to the LEDs 4140 of the first node 4110 that correspond to the red light (R), green light (G), blue light (B), and white light (W) emitted by the LEDs 4140. Stated another way, the microchip 4149 can control the RGB light colors emitted by the LEDs 4140 to control the overall light color emitted by the LED 4140. In at least one embodiment, the microchip 4149 can tune the color of white light being emitted by the LEDs 4140. In other embodiments, the microchip 4149 can control the RGB light color and another light color other than white. In various other embodiments, the microchip 4149 can control any suitable number of light colors. The second end node 4130 comprises the same circuit, or a similar circuit, that controls the six LEDs 4140 thereon. The middle node 4120 also comprises two such circuits, or similar circuits, that control the 12 LEDs 4140 thereon—each circuit controlling six LEDs 4140, for example.

Further to the above, each LED 4140 can comprise one or more pairs of LEDs, or each LED 4140 can comprise a single LED. Moreover, each LED 4140 can comprise a multicolor LED or a single color LED. In various embodiments, the LEDs 4140 can be part of a strip, or strips, that are attached to the printed circuit board 4100. In at least one such embodiment, a LED strip comprises a plurality of LEDs 4140 and the driver circuits that control the colors of the LEDs 4140. In various embodiments, as described above, the LED driver circuits can comprise one or microchips that control the color of the LEDs in response to the control signal received from the controller. In other embodiments, however, the LED driver circuit does not include a microchip. The above being said, any suitable type of light, such as incandescent lights, for example, can be used in addition to or in lieu of the LEDs 4140.

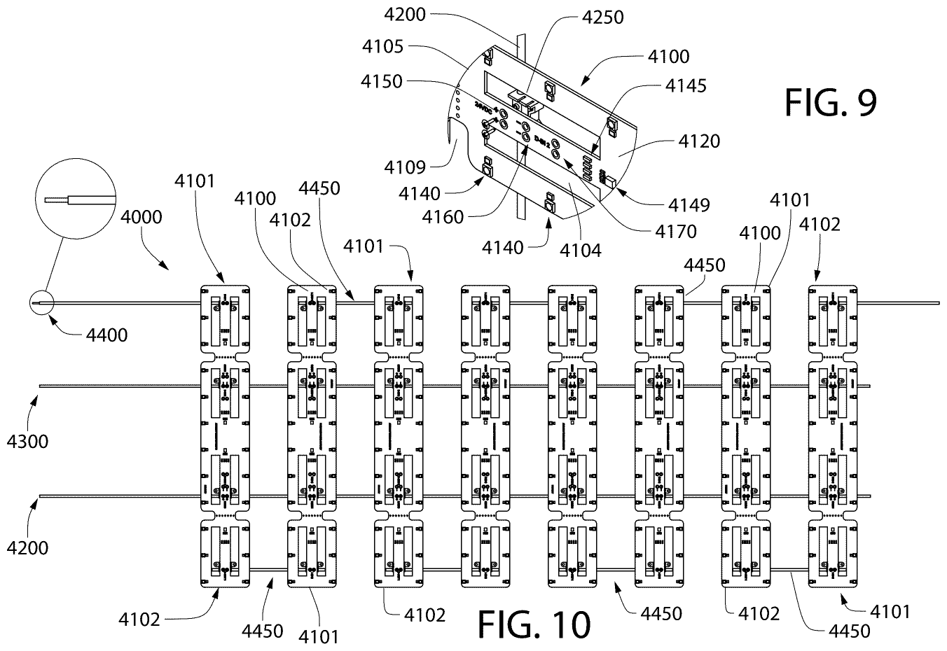

Further to the above, the electrical circuit extending through a printed circuit board 4100 comprises data terminals 4170 in the first end node 4110 thereof that are connectable to the data line 4400. In various embodiments, the data line 4400 comprises an electrical connector configured to engage the data terminals 4170. FIG. 9 illustrates a connector 4250 which is part of the power line 4200 that engages the power terminals 4150, and the connector of the data line 4400 can be similar to the connector 4250. The electrical circuit further comprises data terminals 4170 on the middle node 4120 and data terminals 4170 on the second end node 4170. The data terminals 4170 on the first end node 4110, the middle node 4120, and the second end node 4130 are connected by one or more electrical traces extending through the printed circuit board 4100. In various instances, the electrical traces comprise copper circuits positioned between rigid non-conductive, or at least substantially non-conductive, layers comprised of fiberglass and/or composite epoxy, for example. A layer can be considered substantially non-conductive when any power loss and/or signal loss through the layer is negligible or ignorable. In at least some instances, one or more of the electrical traces can be present on, or printed on, the outer surface of the printed circuit board 4100. In either case, at least one of the pins of the microchips 4149 are soldered to the electrical traces such that the microchips 4149 are in electrical communication with the electrical traces and can receive the control signal from the controller. The above being said, the electrical components of the printed circuit board 4100 can be attached, either electrically or mechanically, in any suitable manner. Moreover, embodiments are contemplated in which the printed circuit board 4100 comprises a flex circuit and is at least partially comprised of a flexible substrate such as polyimide, polyetheretherketone (PEEK), and/or polyester, for example. In various embodiments, the printed circuit board 4100 can include various apertures 4104 defined therein that reduce the weight of the printed circuit board 4100.

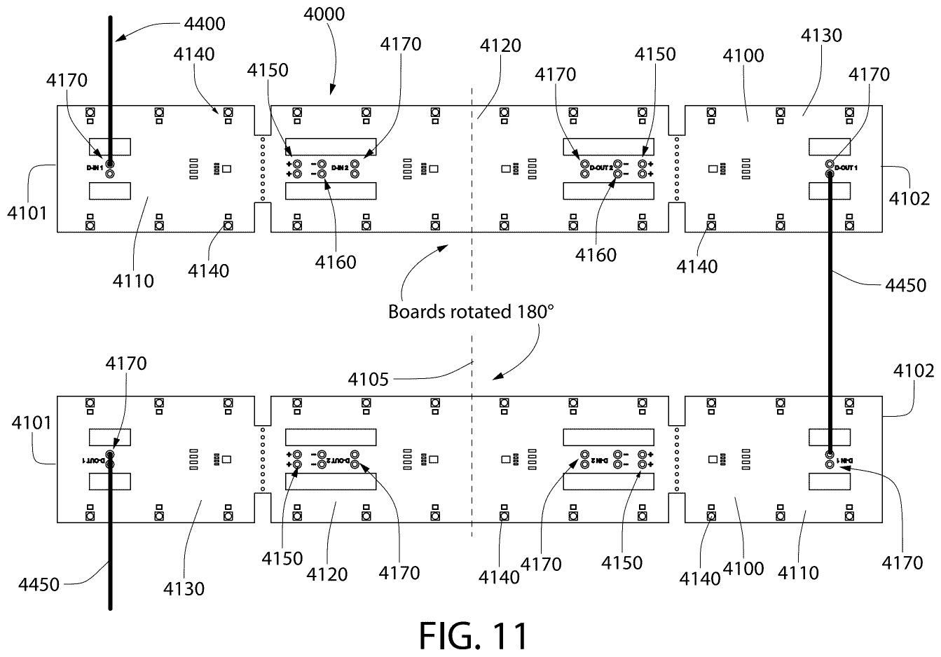

Further to the above, the data terminals 4170 on the second end node 4130 can be used to provide the control signal to an adjacent printed circuit board 4100 in the ladder assembly 4000. Referring to FIGS. 10 and 11, a data line segment, or jumper wire, 4450 is connected to the data terminals 4170 of the second end node 4130 of a first printed circuit board 4100 and the data terminals 4170 on the first end node 4110 of a second, or adjacent, printed circuit board 4100. Similar to the above, the jumper wire 4450 can comprise a first connector that is connected to the data terminals 4170 of the first printed circuit board 4100 and a second connector that is connected to the data terminals 4170 of the second printed circuit board 4100. The second printed circuit board 4100 comprises the same electrical circuit, or a similar electrical circuit, as that of the first printed circuit board 4100. Similar to the above, the second printed circuit board 4100 includes data terminals 4170 on a second end node 4130 thereof that are electrically connected to the data terminals 4170 of a first end node 4110 of a third printed circuit board 4100 by another jumper wire 4450. As a result of the above, the third printed circuit board 4100 receives the control signal from the controller via the first and second printed circuit boards 4100. As illustrated in FIG. 10, the printed circuit boards 4100 of the ladder assembly 4000 are electrically connected in series by a plurality of jumper wires 4450. As a result of the above, each printed circuit board 4100 has an input end, i.e., the first end node 4110, having at least one input data terminal 4170 and an output end, i.e., the second end node 4130, having at least one output data terminal 4170.

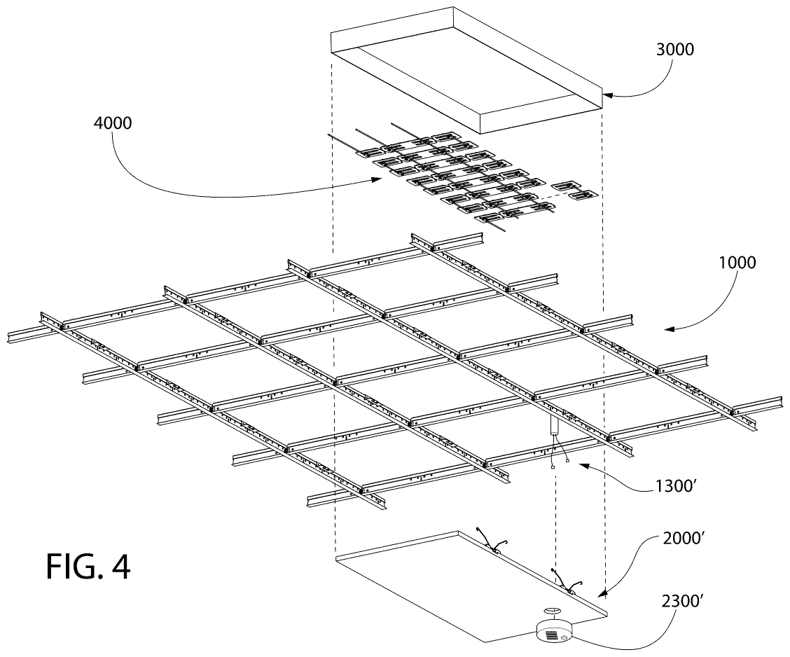

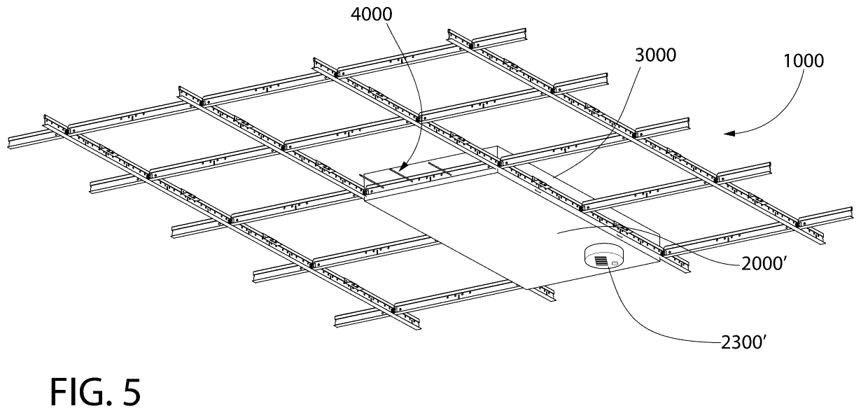

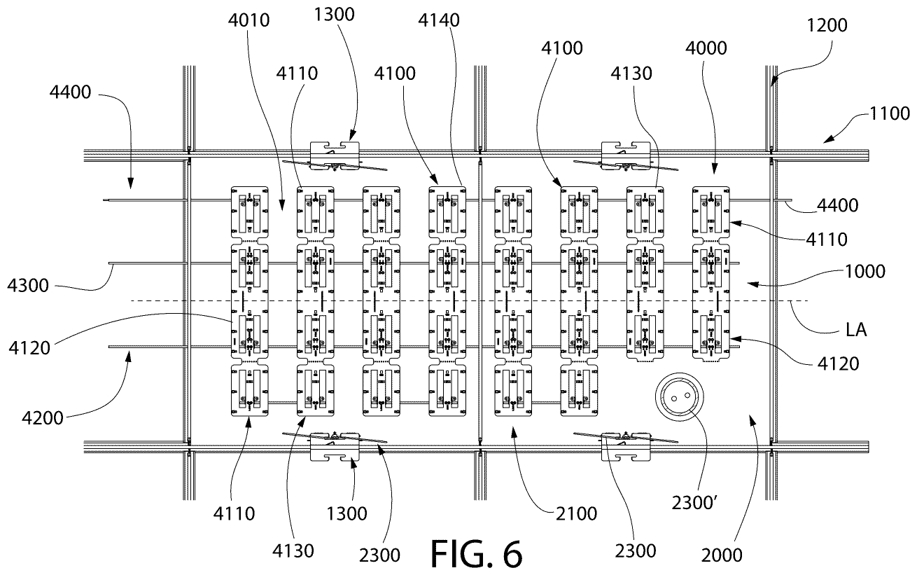

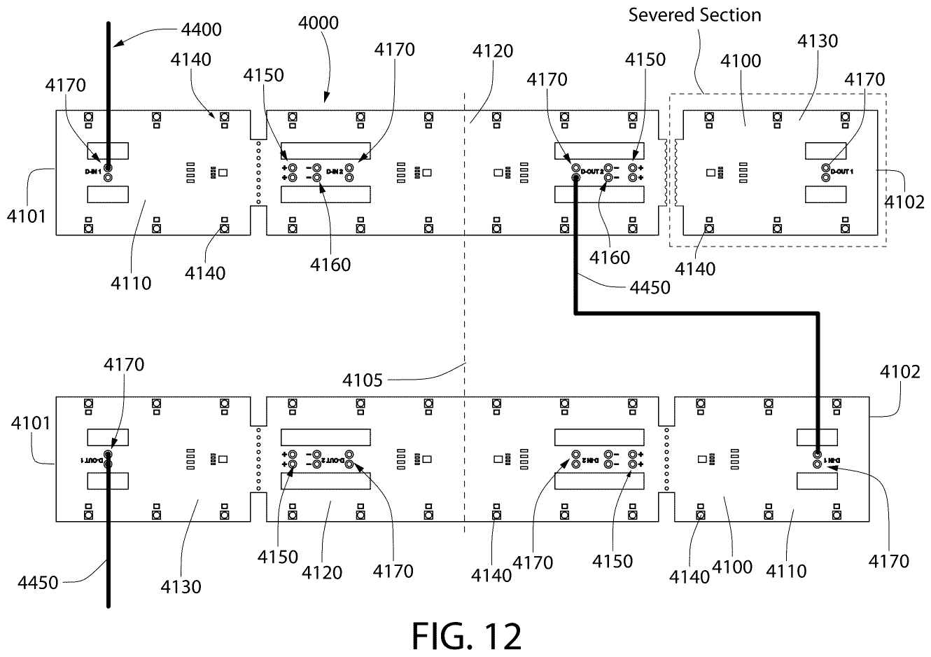

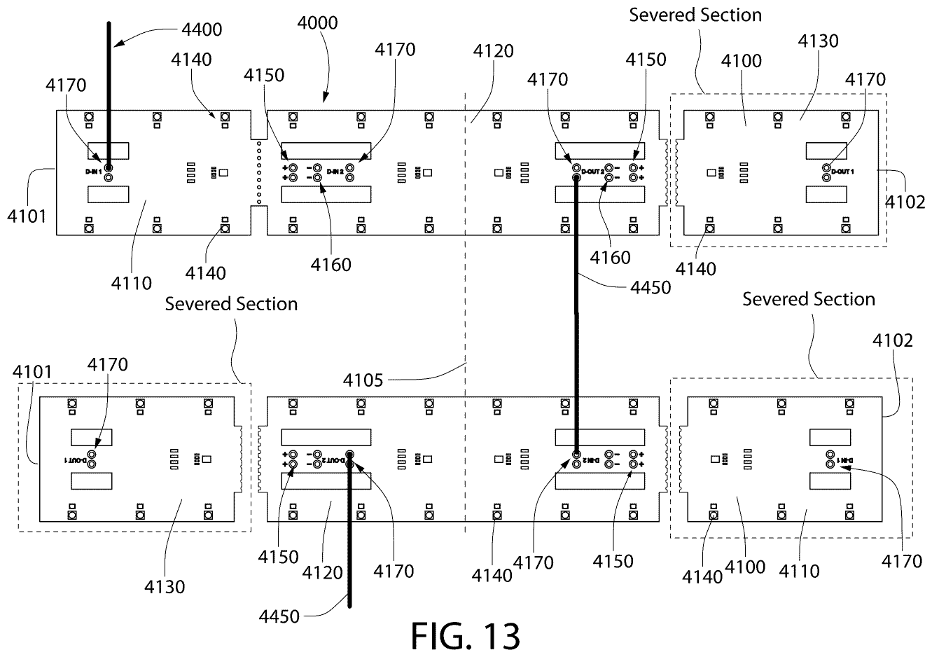

In various instances, further to the above, a ceiling system may need to be adapted to accommodate to the dimensions of a room and/or obstructions created by the building structure. Referring to FIGS. 4-6, the support grid 1000 and/or the ceiling panels 2000 of the ceiling system may be modified to accommodate a fire detection system 2300′, for example. Notably, a ceiling panel 2000 has been modified in FIGS. 4-6 to create a ceiling panel 2000′ having an aperture defined therein configured to accommodate a wire conduit 1300′ that provides power and signal wires to the fire detection system 2300′. Also notably, the wire conduit 1300′ extends through the space occupied by the ladder assembly 4000. To accommodate the wire conduit 1300′, and/or any other building structure, the ladder assembly 4000 can be modified. Referring primarily to FIGS. 12 and 13, a portion of one or more of the printed circuit boards 4100 of the ladder assembly 4000 can be removed to create openings configured to receive one or more building structures therein. In various instances, the first end node 4110 and/or the second end node 4130 of a printed circuit board 4100 can be detached from the middle node 4120 to create the openings. In some instances, the printed circuit board 4100 can be cut with a saw, for example, between the middle node 4120 and the first end node 4110 and/or between the middle node 4120 and the second end node 4130. To facilitate the detachment of the first and/or second end nodes 4110, 4130 from the middle node 4120, the printed circuit board 4100 comprises notches 4119 defined therein. In various instances, the notches 4119 can provide a guide for aligning the saw and/or can reduce the width of the printed circuit board 4100 making the printed circuit board 4100 easier to cut. In various instances, the notches 4119 can allow the first and second end nodes 4110 and 4130 to be broken, or snapped, off from the middle node 4120 by hand.

Referring primarily to FIGS. 7 and 7B, the printed circuit board 4100 comprises a line of through holes, or mousebites, 4115 defined in the printed circuit board 4100 extending between the notches 4119 intermediate the middle node 4120 and the first end node 4110 and another line of mousebites 4115 extending between the notches 4119 intermediate the middle node 4120 and the second end node 4130. In various instances, the mousebites 4115 can permit the first end node 4110 and/or the second end node 4130 to be snapped, or broken, off the middle node 4120 at a breakable detachment interface by hand. The mousebites 4115 are sized and arranged such that the fracture path between the middle node 4120 and the first end node 4110, and/or between the middle node 4120 and the second end node 4130, is contained between the notches 4119 and does not carry into middle node 4120 and/or into the first and second end nodes 4110 and 4130. In addition to or in lieu of the above, the printed circuit board 4100 can comprise any suitable features that can permit a clean break between the nodes 4110, 4120, and 4130 of the printed circuit board 4100. For instance, the printed circuit board 4100 can comprise score marks and/or grooves extending between the sets of notches 4119 defined therein.

As discussed above, each printed circuit board 4100 comprises an electrical circuit, or control circuit, configured to carry a control signal from the controller to the LED driver circuits. As also discussed above, the control circuit extends from the first end node 4110, through the middle node 4120, and into the second end node 4130. In embodiments having the mousebites 4115 defined in the printed circuit board 4100, as discussed above, the traces of the control circuit can extend from the first end node 4110 to the middle node 4120 and then to the second end node 4130 in the substrate of the printed circuit board 4100 between the mousebites 4115 and/or between the mousebites 4115 and the notches 4119. In addition to the control circuit, each printed circuit board 4100 comprises a power circuit. The power circuit extends from the power terminals 4140 on the middle node 4120 laterally to the first end node 4110 and to the second end node 4130 to power the LEDs 4140 thereon. The power circuit also extends from the first end node 4110 and the second end node 4130 back to the ground terminals 4160 on the middle node 4130. Similar to the control circuit, the power circuit comprises copper traces extending between the power terminals 4140 and the first and second end nodes 4110 and 4130 and, likewise, between the first and second end nodes 4110 and 4130 and the ground terminals 4160. Also similar to the control circuit, the traces of the power circuit extend between the middle node 4120 and the first and second end nodes 4110 and 4130 in the substrate of the printed circuit board 4100 inbetween the mousebites 4115 and/or between the mousebites 4115 and the notches 4119.

Further to the above, the printed circuit board 4100 is covered, or at least substantially covered, in a conformal coating. In various embodiments, the conformal coating is comprised of one or more polymeric materials, such as an acrylic and/or a urethane, for example. When the first end node 4110 and/or the second end node 4130 is cut, snapped off, and/or otherwise removed from the middle node 4120, further to the above, the traces of the signal circuit and the power circuit can become exposed along the transected edge(s) of the middle node 4120. In various instances, a conformal coating can be applied to the transected edge(s) to cover, or at least substantially cover, the exposed traces of the signal and/or power circuits. The above being said, embodiments are envisioned without a conformal coating.

When a first end node 4110 and/or the second end node 4130 are removed from a printed circuit board 4100, referring again to FIGS. 12 and 13, the data terminals 4170 thereon are no longer part of the control circuit of the printed circuit board 4100, as modified, and, of course, such data terminals 4170 can no longer be used to connect the control circuit of the modified printed circuit board 4100 with the control circuit of an adjacent printed circuit board 4100 via a jumper wire 4450, for example. In such instances, the control circuits of the modified printed circuit board 4100 and the adjacent printed circuit board 4100 can still be nonetheless connected by a jumper wire 4450. In at least one such instance, the jumper wire 4450 is connected to one or more data terminals 4170 on the middle node 4130 of the modified printed circuit board 4100 to one or more data terminals 4170 on the adjacent printed circuit board 4100. In at least one embodiment, a jumper cable 4450 can connect a data terminal 4170 on the middle node 4120 of a first printed circuit board 4100 to a data terminal 4170 on the first end node 4110 of a second printed circuit board 4100. In at least one embodiment, a jumper cable 4450 can connect a data terminal 4170 on the middle node 4120 of a first printed circuit board 4100 to a data terminal 4170 on the middle node 4120 of a second printed circuit board 4100. In at least one embodiment, a jumper cable 4450 can connect a data terminal 4170 on the second end node 4130 of a first printed circuit board 4100 to a data terminal 4170 on the middle node 4120 of a second printed circuit board 4100. The above being said, any suitable arrangement can be used.

As discussed above, the control circuits of the printed circuit boards 4100 are configured to control the LEDs 4140 in response to a control signal provided by the data line 4400. In various embodiments, the control circuits of the first end nodes 4110 of a ladder lighting assembly 4000 are configured to respond to a first portion of the control signal, the middle nodes 4120 are configured to respond to a second portion of the control signal, and the second end nodes 4130 are configured to respond to a third portion of the control signal. In at least one embodiment, the control circuits of the first end nodes 4110, the middle nodes 4120, and the second end nodes 4130 have one or more filter circuits configured to control the data to and/or the data through the microchips 4149. In various embodiments, as a result, a first group of LEDs 4140 on the first end nodes 4110 of a ladder lighting assembly 4000 can be illuminated with a first color and/or intensity, a second group of LEDs 4140 on the middle nodes 4120 of the ladder lighting assembly 4000 can be illuminated with a second color and/or intensity that is different than the first color and/or intensity, and a third group of LEDs 4140 on the second end nodes 4130 of the ladder lighting assembly 4000 can be illuminated with a third color and/or intensity that is different than the first and second colors and/or intensities. In at least one embodiment, a first printed circuit board 4100 of a ladder lighting assembly 4000 is responsive to a control signal in a first manner, a second printed circuit board 4100 of the ladder lighting assembly 4000 is responsive to the control signal in a second manner that is different than the first manner, and a third printed circuit board 4100 of the ladder lighting assembly 4000 is responsive to the control signal in a third manner that is different than the first manner and the second manner. In at least some such embodiments, the control circuits on the first printed circuit board 4100 have a first filtering circuit, the control circuits on the second printed circuit board 4100 have a second filtering circuit that is different than the first filtering circuit, and the control circuits on the third printed circuit board 4100 have a third filtering circuit that is different than the first filtering circuit and the second filtering circuit.

In various embodiments, referring primarily to FIG. 1, the LEDs 4140 of a lighting assembly 4000 face upwardly away from the backside of a ceiling panel 2000, for example. In such embodiments, a backlight tray 3000 positioned behind the lighting assembly 4000 can be configured to contain, reflect, direct, and/or focus the light emitted by the LEDs 4140. In at least one embodiment, the backlight tray 3000 comprises a metal panel, for example. In addition to or in lieu of the above, the backlight tray 3000 can comprise a diffusing plastic lens. In at least one such embodiment, the diffusing plastic lens is comprised of polycarbonate, for example. In various embodiments, the diffusing plastic lens comprises a frosted translucent backer that diffuses the light emitted by the LEDs 4140 to create an aesthetic lighting effect. The above being said, the diffusing lens can be made of materials other than plastic, such as frosted glass, for example. In addition to or in lieu of the above, the LEDs of a lighting assembly can face downwardly toward the backside of a ceiling panel 2000, for example. In various instances, the light emitted by the LEDs contacts the backside of the ceiling panel 2000 and reflects off the ceiling panel 2000 which can create a diffusing effect of the light emitted by the LEDs. Such embodiments may also employ the backlight tray 3000, for example. Moreover, in addition to or in lieu of the above, a component can be positioned over one or more of the LEDs 4140 of a lighting assembly 4000 to control the spread of the light and/or diffuse the light emitted therefrom. In at least one such embodiment, the component comprises a batwing diffuser, for example. In various embodiments, a batwing diffuser can widen the spread of a light beam emitted from a LED 4140 or multiple LEDs 4140. In various embodiments, all of the LEDs 4140 of a lighting assembly 4000 are directly covered by diffusing components while, in other embodiments, less than all of the LEDs 4140 of a lighting assembly 4000 are directly covered by diffusing components.

As described above, each printed circuit board 4100 comprises a first end node 4110, a middle node 4120, and a second end node 4130. That said, other embodiments are envisioned in which a printed circuit board has any suitable number of severable nodes. For instance, a printed circuit board can have two nodes, four nodes, five nodes, or six nodes, for example, that are severable from one another. Moreover, the middle node 4120 of the printed circuit board 4100 is itself severable into two nodes. As discussed above, the middle node 4120 has two sets of terminals 4150, 4160, and 4170 and, if the middle node 4120 were to be transected at a location intermediate the sets of terminals, such as along the centerline 4105, for example, the middle node 4120 becomes two separate, functional nodes each having a set of terminals 4150, 4160, and 4170.

The embodiments disclosed herein have been described in connection with a ceiling system; however, it should be understood that these embodiments can be adapted for use with a wall system. Such embodiments can be adaptable to accommodate building structures such as doors and/or windows, for example. Moreover, various embodiments disclosed herein have been described as having a ladder-like arrangement; however, it should be noted that various other embodiments are contemplated which have other configurations. For instance, at least one embodiment is envisioned in which printed circuit boards 4100 are arranged in a polygonic arrangement, such as a square arrangement, for example. In at least one such embodiment, power, ground, and/or signal wires can extend in a multitude of directions. For instance, some wires can extend in a first direction and other wires can extend in a second, or transverse, direction. In various embodiments, a lighting assembly can have horizontally arranged printed circuit boards that extend along longitudinal axes and/or extend parallel to a central longitudinal axis of a lighting assembly. In various embodiments, a lighting assembly can comprise any suitable matrix of printed circuit boards.

As discussed above, various lighting assemblies are disclosed herein which comprise a power line, a ground line, and a data line. That said, a lighting assembly can comprise any suitable number of lines and/or types of lines. For instance, a lighting assembly can comprise an additional data line for a clock, i.e., a clock line, to control the refresh rates of the LEDs 4140 and/or LED driver circuits, for example. In at least one such embodiment, the clock line is in communication with a controller and transmits a clock data signal to all of the printed circuit boards of a lighting assembly and/or to multiple lighting assemblies. In such embodiments, each node of a printed circuit board can comprise a clock circuit including a clock terminal configured to be coupled to the clock line via a connector. In at least one such embodiment, the power terminal 4150, the ground terminal 4160, the data terminal 4170, and the clock terminal are arranged in a row which can facilitate the connection of, respectively, the power line, the ground line, the data line, and the clock line thereto via a common wiring harness connector or a plurality of individual connectors.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A ladder lighting system comprising:
a first printed circuit board, comprising:
a first group of light emitting diodes;
a first control circuit configured to control the first group of light emitting diodes;
a first power terminal in electrical communication with the first control circuit;
a first data input terminal in electrical communication with the first control circuit; and
a first data output terminal;
a second printed circuit board, comprising:
a second group of light emitting diodes;
a second control circuit configured to control the second group of light emitting diodes;
a second power terminal in electrical communication with the second control circuit;
a second data input terminal in electrical communication with the second control circuit; and
a second data output terminal;
a power line connected to the first power terminal and the second power terminal; and
a data line, comprising:
a first data line segment connected to the first data input terminal;
a second data line segment connected to the first data output terminal and the second data input terminal; and
a third data line segment connected to the second data output terminal.

2. The ladder lighting system of claim 1, wherein the first printed circuit board further comprises a first ground terminal, wherein the second printed circuit board further comprises a second ground terminal, and wherein the ladder lighting system further comprises a ground line connected to the first ground terminal and the second ground terminal.

3. The ladder lighting system of claim 1, wherein the first printed circuit board and the second printed circuit board comprise parallel rungs.

4. The ladder lighting system of claim 3, wherein the first printed circuit board comprises a first input end segment and a first output end segment, wherein the first input end segment comprises the first data input terminal, wherein the first output end segment comprises the first data output terminal, wherein the second printed circuit board comprises a second input end segment and a second output end segment, wherein the second input end segment comprises the second data input terminal, and wherein the second output end segment comprises the second data output terminal.

5. The ladder lighting system of claim 4, wherein the first printed circuit board and the second printed circuit board are arranged such that:
the first input end segment of the first printed circuit board is aligned with the second output end segment of the second printed circuit board; and
the first output end segment of the first printed circuit board is aligned with the second input end segment of the second printed circuit board.

6. The ladder lighting system of claim wherein the first printed circuit board further comprises:
a first detachment interface intermediate the first input end segment and a first intermediate segment configured to permit the first input end segment to detach from the first intermediate segment; and
a second detachment interface intermediate the first output end segment and the first intermediate segment configured to permit the first output end segment to detach from the first intermediate segment.

7. The ladder lighting system of claim 6, wherein the first intermediate segment comprises a first data input terminal and a first data output terminal.

8. The ladder lighting system of claim 6, wherein the second printed circuit board further comprises:
a first detachment interface intermediate the second input end segment and a second intermediate segment configured to permit the second input end segment to detach from the second intermediate segment; and
a second detachment interface intermediate the second output end segment and the second intermediate segment configured to permit the second output end segment to detach from the second intermediate segment.

9. (canceled)

10. The ladder lighting system of claim 1, wherein the first intermediate segment comprises a first intermediate group of light emitting diodes and a first intermediate control circuit configured to control the first intermediate group of light emitting diodes, and wherein the second intermediate segment comprises a second intermediate group of light emitting diodes and a second intermediate control circuit configured to control the second intermediate group of light emitting diodes.

11.-17. (canceled)

18. The ladder lighting system of claim 1, wherein the first printed circuit board is identical to the second printed circuit board.

19. The ladder lighting system of claim 1, wherein the second printed circuit board is rotated 180 degrees relative to the first printed circuit board.

20. The ladder lighting system of claim 1, further comprising a controller in electrical communication with the first control circuit and the second control circuit via the data line, and wherein the controller is configured to emit a control signal from which the first control circuit and the second control circuit can extract data to control the first group of light emitting diodes and the second group of light emitting diodes.

21. A ladder lighting assembly comprising:
a plurality of printed circuit board rungs, each printed circuit board rung comprising:
a first node, comprising:
a first board segment;
a first group of light emitting diodes;
a first control circuit configured to conduct a control signal;
a first driver circuit in electrical communication with the first control circuit, wherein the first driver circuit is configured to control the first group of light emitting diodes in response to the control signal;
a first power terminal in electrical communication with the first driver circuit; and
a first signal terminal in electrical communication with the first control circuit;
a second node, comprising:
a second board segment removably attached to the first board segment;
a second group of light emitting diodes;
a second control circuit in electrical communication with the first control circuit configured to conduct the control signal;
a second driver circuit in electrical communication with the second control circuit, wherein the second driver circuit is configured to control the second group of light emitting diodes in response to the control signal; and
a second signal terminal in electrical communication with the second control circuit; and
a data line connecting the second signal terminal of one of the printed circuit board rungs to the first signal terminal of another one of the printed circuit board rungs.

22. The ladder lighting assembly of claim 21, wherein each printed circuit board further comprises a line of mousebites between the first board segment and the second board segment configured to facilitate the detachment of the second board segment from the first board segment.

23. The ladder lighting assembly of claim 21, wherein each printed circuit board further comprises cut-outs between the first board segment and the second board segment.

24. (canceled)

25. The ladder lighting assembly of claim 21, wherein each printed circuit board rung further comprises a third node comprising:
a third board segment removably attached to the first board segment;
a third group of light emitting diodes;
a third control circuit in electrical communication with the first control circuit configured to conduct the control signal;
a third driver circuit in electrical communication with the third control circuit, wherein the third driver circuit is configured to control the third group of light emitting diodes in response to the control signal; and
a third signal terminal in electrical communication with the third control circuit.

26. The ladder lighting assembly of claim 25, wherein the data line connects the second signal terminal of one of the printed circuit board rungs to a third signal terminal of another one of the printed circuit board rungs.

27.-31. (canceled)

32. An architectural panel system, comprising:
at least one architectural panel; and
at least one lighting assembly, each lighting assembly comprising:
a plurality of circuit boards, wherein each circuit board comprises a plurality of severable nodes; and
a data circuit extending through the plurality of circuit boards.

33. The architectural panel system of claim 32, wherein the architectural panel comprises a ceiling panel.

34. The architectural panel system of claim 32, wherein the architectural panel comprises a wall panel.
